(19) United States
(12) Patent Application Publication
(10) Pub. No.: US 2015/0125721 A1
(43) Pub. Date: May 7, 2015

(54) LITHIUM SECONDARY BATTERY WITHOUT THE NEED OF GAS REMOVAL PROCESS

(71) Applicant: LG Chem, Ltd., Seoul (KR)

(72) Inventor: Du-Seong Yoon, Daejeon (KR)

(73) Assignee: LG CHEM, LTD., Seoul (KR)

(21) Appl. No.: 14/526,615

(22) Filed: Oct. 29, 2014

(30) Foreign Application Priority Data
Nov. 1, 2013 (KR) 10-2013-0132432
Oct. 16, 2014 (KR) 10-2014-0140057

(51) Int. Cl. H01M 10/52; H01M 2/02; H01M 10/052

(52) U.S. Cl. CPC H01M 10/52; H01M 10/052; H01M 2/0257
USPC 429/57

(57) ABSTRACT

The present disclosure provides a lithium secondary battery, which does not need a separate process for removing gases. The lithium secondary battery of the present disclosure comprises an electrode assembly configured to have a cathode, an anode, and a separator interposed therebetween, and a battery case for receiving the electrode assembly and an electrolyte solution, wherein the battery case has a gas-removing agent in one inner side thereof, the gas-removing agent not coming into contact with the other components within the battery case.

### CROSS-REFERENCE TO RELATED APPLICATION

This application claims priority to Korean Patent Application No. 10-2013-0132432 filed in the Republic of Korea on Nov. 1, 2013 and Korean Patent Application No. 10-2014-0140057 filed in the Republic of Korea on Oct. 16, 2014, which are incorporated herein by reference.

### BACKGROUND OF THE DISCLOSURE

1. Field of the Disclosure

The present disclosure relates to a lithium secondary battery, more specifically to a lithium secondary battery which does not need a separate process for removing gases being generated during the battery is activated or as the battery is degraded.

2. Description of the Related Art

Generally, secondary batteries are referred to as rechargeable batteries because they can be charged and discharged repeatedly, unlike a primary battery incapable of recharging, and widely used as a power source in electronic devices such as cellular phones, notebook computers and camcorders, or electric vehicles. Particularly, a lithium secondary battery has an operating voltage of 3.6 V or more, which is three times higher than those of Ni—Cd batteries or Ni—H batteries mainly used as the power source of electronic equipments and has excellent energy density characteristics per unit weight, and thus, the use of the lithium secondary battery is rapidly increasing.

Such a lithium secondary battery mainly uses a lithium-based oxide and a carbon material as a cathode active material and an anode active material, respectively. The lithium secondary battery comprises an electrode assembly in which a cathode, a separator and an anode are sequentially disposed, and a cladding, i.e., a battery case for sealing and receiving the electrode assembly together with an electrolyte solution therein.

Meanwhile, according to the shape of the battery case, the lithium secondary battery may be classified as a can-type secondary battery in which an electrode assembly is put in a metallic can, or a pouch-type secondary battery in which an electrode assembly is put in a pouch of an aluminum-laminated sheet. Also, the can-shaped battery may be a cylindrical battery and a prismatic battery, according to the form of the metallic can.

FIG. 1 schematically shows the configuration of a conventional pouch-type secondary battery, and FIG. 2 shows a cross-section of the pouch-type secondary battery of FIG. 1.

Referring to FIGS. 1 and 2, a secondary battery comprises a case, an electrode assembly, electrode taps, and electrode leads.

A case 11 may be formed to have a size capable of receiving an electrode assembly 12, electrode taps 13, and electrode leads 14 which will be described below.

The electrode assembly 12 comprises a cathode, a separator, and an anode which may be laminated in order. Representatively, the electrode assembly may be constructed in a jelly-roll (winding type) structure obtained by interposing a separator between a sheet-formed cathode and an sheet-formed anode, followed by winding; in a stacked (lamination type) structure obtained by interposing separators between multiple cathode units and multiple anode units being cut into a predetermined size, followed by sequentially stacking; or in a stack-folded structure obtained by interposing separators between multiple cathode units and multiple anode units, followed by sequentially stacking to form bi-cells or full-cells, and winding the bi-cells or full-cells.

The electrode taps 13 extend from the electrode assembly 12. For example, a cathode tap extends from a cathode, and an anode tap extends from an anode. In the case that the electrode assembly 12 consists of multiple cathodes and multiple anodes which are laminated, the electrode taps 13 extend from each of the cathodes and the anodes. The electrode taps 13 may be connected to other components, such as the electrode leads 14, so that the taps are not directly exposed to the outside of the case 11.

The electrode leads 14 are electrically connected to each electrode tap 13 that extends from a cathode or an anode in a portion thereof. That is, the cathode lead is combined with the cathode tap for electrical connection, and the anode lead is combined with the anode tap for electrical connection. On the top or bottom of the electrode leads, an insulating film may be partially attached to enhance a sealing degree of the battery case and to ensure electrical insulation.

Such a conventional lithium secondary battery undergoes gas generation by the decomposition of an electrolyte solution during battery activation or from battery degradation. The gas being generated may accelerate the battery degradation, and therefore, it is necessary for the gas to be removed.

However, a separate process of removing the gas increases production expense.

### SUMMARY OF THE DISCLOSURE

The present disclosure is designed to solve the problems of the related art, and therefore the present disclosure is directed to providing a lithium secondary battery having activated carbon therein, which does not need a separate process for removing gases being generated during activation or degradation of the battery.

In accordance with one aspect of the present disclosure, there is provided a lithium secondary battery, comprising an electrode assembly configured to have a cathode, an anode, and a separator interposed therebetween, and a battery case for receiving the electrode assembly and an electrolyte solution, wherein the battery case has a gas-removing agent in one inner side thereof, the gas-removing agent not coming into contact with the other components within the battery case.

The gas-removing agent may be activated carbon.

The battery case may be a metallic case or a pouch case.

When the battery case is a pouch case, the gas-removing agent may be attached in the longitudinal direction that an electrode lead is formed in the inner side of the battery case.

When the battery case is a metallic case, the gas-removing agent may be attached on an inner circumference of a cap covering the top of the electrode assembly.

The gas-removing agent may be obtained by mixing a gas adsorbent and a resin, followed by curing.

The gas adsorbent may comprise any one selected from the group consisting of nickel (Ni), platinum (Pt), palladium (Pd), calcium (Ca), strontium (Sr), barium (Ba), titanium (Ti), zirconium (Zr), hafnium (Hf), vanadium (V), niobium (Nb), tantalum (Ta), chromium (Cr), molibdenium (Mo), tungsten (W), and a combination thereof.

The lithium secondary battery according to one aspect of the present disclosure has activated carbon therein to allow the removal of gases being generated during battery activation, even though a separate process of removing the gases is not carried out, thereby lowering production expense.

Also, gases generated from battery degradation can be removed by the activation carbon, thereby remarkably reducing load being applied to the external material of the battery, i.e., the battery case.

### BRIEF DESCRIPTION OF THE DRAWINGS

The accompanying drawings illustrate preferred embodiments of the present invention and, together with the foregoing disclosure, serve to provide further understanding of the technical spirit of the present invention. However, the present invention is not to be construed as being limited to the drawings.

FIG. 1 schematically shows the configuration of a conventional pouch-type secondary battery.

FIG. 2 shows a cross-section of the pouch-type secondary battery of FIG. 1.

FIG. 3 shows the configuration of a pouch-type secondary battery according to one embodiment of the present disclosure.

FIG. 4 shows a cross-section taken along with the IV-IV′ line of FIG. 3.

FIG. 5 shows the configuration of a can-type (cylindrical) secondary battery according to another embodiment of the present disclosure.

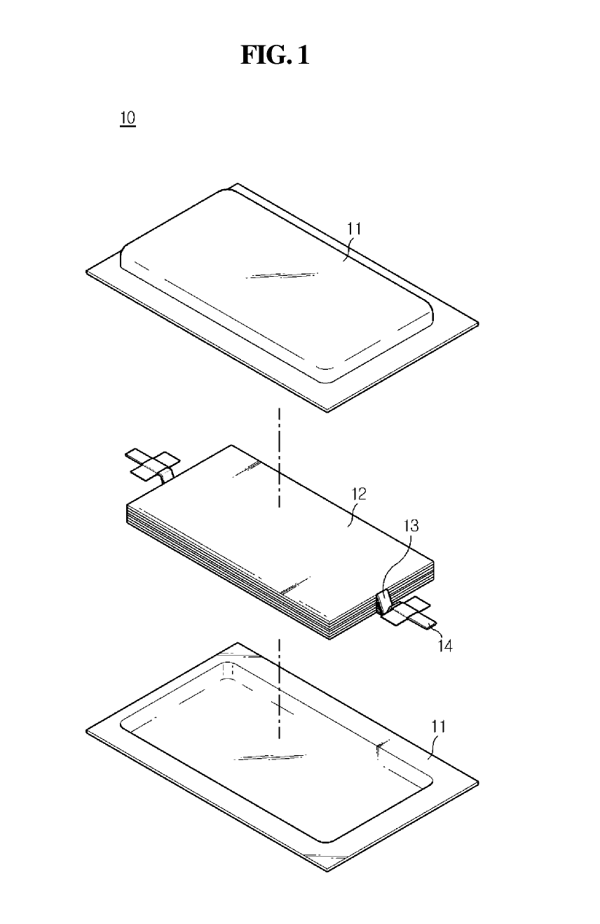

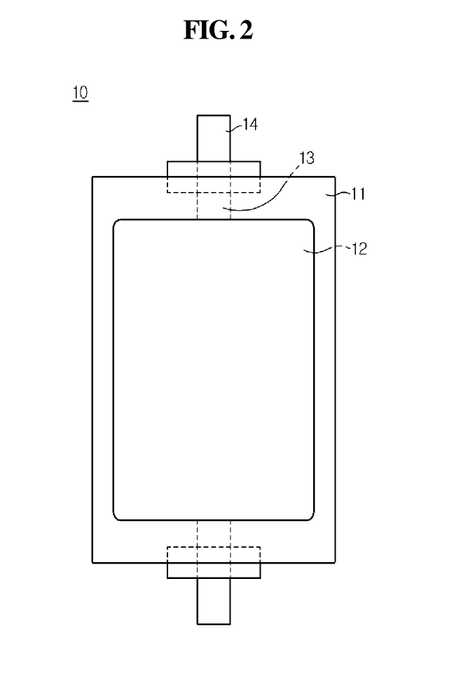

<Explanation of Reference Numerals>

| | |
|---|---|
| 110: Case | 120, 520: Electrode assembly |
| 130: Electrode tap | 140: Electrode lead |

150, 540: Gas-removing agent

### DESCRIPTION OF THE PREFERRED EMBODIMENT

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the constitution of the embodiments and drawings presented herein is just a preferable example for the purpose of illustrations only, not intended to limit the scope of the disclosure, so it should be understood that other equivalents and modifications could be made thereto without departing from the spirit and scope of the disclosure.

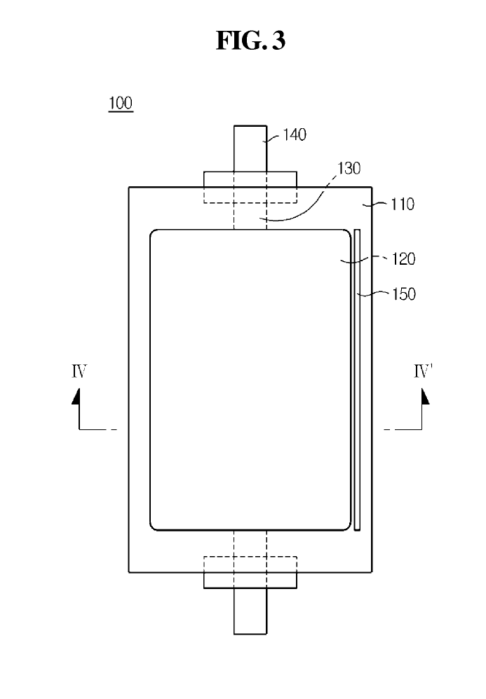

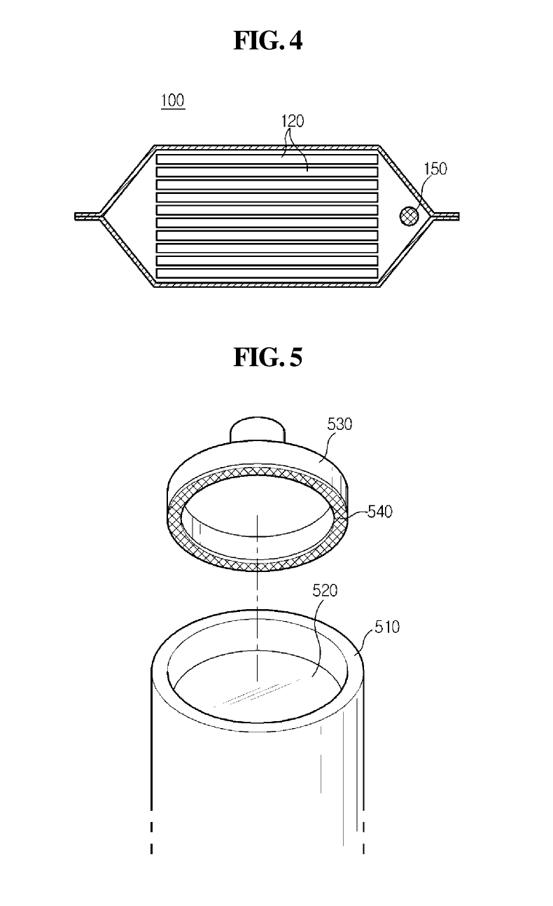

FIG. 3 shows the configuration of a pouch-type secondary battery according to one embodiment of the present disclosure, and FIG. 4 shows a cross-section taken along with the IV-IV′ line of FIG. 3.

Referring to FIG. 3, a secondary battery 100 according to the present disclosure comprises a case 110, an electrode assembly 120, electrode tap 130, electrode leads 140, and a gas-removing agent 150.

The case 110 has empty inside space in which the electrode assembly 120 may be received. The case 110 may be formed in a hexahedron or prismatic shape, but the present invention is not limited to a particular shape of the case 110.

The electrode assembly 120 comprises a cathode, an anode, and a separator. That is, the electrode assembly 120 is obtained in the insulated state by sequentially laminating a cathode and an anode between which a separator is interposed. The electrode assembly 120 may have various structures including winding, stacked, and stack-folded types, according to embodiments.

The cathode comprises a cathode current collector made of a metallic thin film with good conductivity, such as an aluminum (Al) foil, and a cathode active material layer formed by way of coating on both surfaces of the cathode current collector. The cathode may have uncoated regions that have no coating of a cathode active material on both surfaces of the cathode current collector. Also, the cathode may be provided with a cathode tap being welded at one end of the uncoated regions and being made of a metallic material, such as aluminum (Al).

The anode comprises an anode current collector made of a conductive metallic thin film, such as a copper (Cu) foil, and an anode active material layer formed by way of coating on both surfaces of the anode current collector. The anode may have uncoated regions that have no coating of an anode active material on both surfaces of the anode current collector. Also, the anode may be provided with an anode tap being welded at one end of the uncoated regions and being made of a metallic material, such as nickel (Ni). Each number of the cathode and the anode may be two or more according to the structure of the electrode assembly 120. In particular, a stack-structured electrode assembly may comprise multiple cathodes and multiple anodes.

The separator is interposed between the cathode and the anode to electrically insulate them, and may be made in the form of a porous membrane so as for lithium ions to pass between the cathode and the anode. For example, the separator may be a porous membrane made of polyethylene (PE), polypropylene (PP), or a mixture thereof.

The electrode taps 130 extend from the electrode assembly 120. Such an electrode tap 130 may be connected to other components, such as the electrode leads 140, so that the taps are not directly exposed to the outside of the case 110.

The electrode leads 140 are electrically connected to each electrode tap 130. One end of such an electrode leads 140 may be connected to the electrode tap 130, and the other end thereof is exposed to the outside of the case 110, the other end being exposed to the outside functions as an electrode terminal. Thereby, the other end of the electrode leads is connected with a charger or load so as for the secondary battery to be charged and discharged. Also, on the top or bottom of the electrode leads, an insulating film may be partially attached to enhance a sealing degree of the battery case and to ensure electrical insulation.

The gas-removing agent 150 functions to remove gases being generated during activation by charge and discharge of the secondary battery or from the degradation thereof. As shown in FIGS. 3 and 4, the gas-removing agent 150 may be attached in the longitudinal direction that an electrode lead is formed in the inner side of the battery case, so that the agent does not come into contact with the electrode assembly in the inner side of the battery case. The gas-removing agent may be activated carbon. The activated carbon, which has strong adsorptivity and mostly consists of carbonaceous materials, can be used to absorb gases or moisture as an adsorbent or can be used as a decolorant. In the present disclosure, the activated carbon functions as an agent for removing gases generated within the battery. Also, the gas-removing agent is not limited to the activated carbon, and it may be one being obtained by mixing a gas adsorbent and a resin, followed by curing. The gas adsorbent may comprise any one selected from the group consisting of nickel (Ni), platinum (Pt), palladium (Pd), calcium (Ca), strontium (Sr), barium (Ba), titanium (Ti), zirconium (Zr), hafnium (Hf), vanadium (V), niobium (Nb), tantalum (Ta), chromium (Cr), molibdenium (Mo), tungsten (W), and a combination thereof. Also, the gas adsorbent may be a porous metal oxide. The porous metal oxide may be any one selected from the group consisting of zeolite, silica gel, alumina, molecular sieves, and a mixture thereof.

Conventional secondary batteries often need a separate process of removing gases generated during charging and discharging processes or from overcharging. In contrast, the secondary battery of the present disclosure has a substance capable of removing gases in the inner side of the case 110, thereby allowing gas removal without a separate process, from which production expense can be lowered. Also, gases generated from battery degradation, which may expand the battery to bring about explosion, can be collected by the activation carbon, thereby remarkably reducing load being applied to the secondary battery.

Besides the above-mentioned pouch-type secondary battery, the present disclosure can be applied in a secondary battery having a can-type case. As shown in FIG. 4, the gas-removing agent may be attached on an inner circumference of a cap 530 which is positioned in the top portion of the electrode assembly 520 to cover an opening for entrance of the electrode assembly 520, thereby removing gases being generated during the activation of the secondary battery or from the degradation thereof.

The present invention is not limited to such a configuration, the gas-removing agent may be attached on anywhere within the case unless it comes into contact with the internal components of the secondary battery.

The foregoing disclosure has been described through the limited examples and drawings, and is not intended to limit the scope of the present invention. Various changes and modifications within the spirit and scope of the disclosure will become apparent to those skilled in the art from this detailed description.

What is claimed is:

1. A lithium secondary battery, comprising:
an electrode assembly configured to have a cathode, an anode, and a separator interposed therebetween, and
a battery case for receiving the electrode assembly and an electrolyte solution,
wherein the battery case has a gas-removing agent in one inner side thereof, the gas-removing agent not coming into contact with the other components within the battery case.

2. The lithium secondary battery claim 1, wherein the gas-removing agent is activated carbon.

3. The lithium secondary battery claim 1, wherein the battery case is a metallic case or a pouch case.

4. The lithium secondary battery claim 3, wherein when the battery case is a pouch case, the gas-removing agent is attached in the longitudinal direction that an electrode lead is formed in the inner side of the battery case.

5. The lithium secondary battery claim 3, wherein when the battery case is a metallic case, the gas-removing agent is attached on an inner circumference of a cap covering the top of the electrode assembly.

6. The lithium secondary battery claim 1, wherein the gas-removing agent is obtained by mixing a gas adsorbent and a resin, followed by curing.

7. The lithium secondary battery claim 6, wherein the gas adsorbent comprises any one selected from the group consisting of nickel (Ni), platinum (Pt), palladium (Pd), calcium (Ca), strontium (Sr), barium (Ba), titanium (Ti), zirconium (Zr), hafnium (Hf), vanadium (V), niobium (Nb), tantalum (Ta), chromium (Cr), molibdenium (Mo), tungsten (W), and a combination thereof.
